(19) United States
(12) Patent Application Publication
(10) Pub. No.: US 2025/0190362 A1
(43) Pub. Date: Jun. 12, 2025

(54) HYPERCALL METHOD AND APPARATUS FOR KERNEL-MODE PROGRAM OF EXTENDED BERKELEY PACKET FILTER

(71) Applicant: CLOUD INTELLIGENCE ASSETS HOLDING (SINGAPORE) PRIVATE LIMITED, SINGAPORE (SG)

(72) Inventor: Xiaokang HU, Zhejiang (CN)

(73) Assignee: CLOUD INTELLIGENCE ASSETS HOLDING (SINGAPORE) PRIVATE LIMITED, SINGAPORE (SG)

(21) Appl. No.: 18/846,257

(22) PCT Filed: Mar. 8, 2023
(86) PCT No.: PCT/CN2023/080339

§ 371 Date: Sep. 12, 2024

(30) Foreign Application Priority Data
Mar. 14, 2022 (CN) 202210249016.0

(51) Int. Cl. G06F 12/1036; G06F 9/455

(52) U.S. Cl. CPC G06F 12/1036; G06F 9/45558; G06F 2009/45583; G06F 2009/45591

(57) ABSTRACT

A hypercall method and apparatus for a kernel-mode program of an enhanced Berkeley packet filter are disclosed. The method is applied to a virtual machine monitor, comprises: acquiring, in response to a virtualization page fault triggered by the kernel-mode program, a memory address where the virtualization page fault is triggered; determining whether the memory address of the virtualization page fault is consistent with a memory address corresponding to a page fault key in a mapping table; reading, from the mapping table, a page fault value mapped by the page fault key if the memory address of the virtualization page fault is consistent with the memory address corresponding to the page fault key, wherein the page fault value comprises a function type of a hypercall written by the kernel-mode program; and executing, based on the function type indicated by the page fault value, the hypercall of the function type.

### CROSS REFERENCE TO PRIORITY APPLICATIONS

This application is a U.S. National Stage Patent Application under 35 U.S.C. § 371 of International PCT Patent Application PCT/CN2023/080339, filed Mar. 8, 2023, and entitled “HYPERCALL METHOD AND APPARATUS FOR KERNEL-MODE PROGRAM OF ENHANCED BERKELEY PACKET FILTER”, which claims priority to Chinese Patent Application No. 202210249016.0, filed with the China Patent Office on Mar. 14, 2022 and titled “HYPERCALL METHOD AND APPARATUS FOR KERNEL-MODE PROGRAM OF EXTENDED BERKELEY PACKET FILTER”, both of which are incorporated herein by reference in their entireties.

### TECHNICAL FIELD

Embodiments of this specification relate to the field of computer technology, and, especially, to a hypercall method and apparatus for a kernel-mode program of an extended Berkeley packet filter.

### BACKGROUND

The extended Berkeley packet filter (eBPF) is a general-purpose execution engine. The extended Berkeley packet filter is commonly used by developers since it can run special programs (e.g., sandbox programs) in an operating system kernel (e.g., the Linux kernel) without changing kernel source codes or loading kernel modules.

An architecture of the extended Berkeley packet filter at least may include two parts, i.e., a user-mode program (or a user space program) and a kernel-mode program (or a kernel program). The user-mode program is used to load an instruction code (e.g., a BPF bytecode) to a kernel, or may also read information or an event returned by the kernel, while the kernel-mode program is used to convert the instruction code into a kernel-executable instruction, which, in turn, is executed by an instruction program in the kernel.

A hyper call (Hypercall) mechanism is provided in a virtualized environment (e.g., a virtual machine), and mode switch from a user mode to a kernel mode may be implemented by calling Hypercall, thereby acquiring a higher operation permission in the kernel mode.

But the extended Berkeley packet filter running in the virtualized environment, if desiring to acquire a higher operation permission, needs to switch from a kernel-mode program to a virtual machine monitor (Hypervisor, or VMM) at a lower level of the virtual machine. However, a kernel-mode program of an existing extended Berkeley packet filter cannot call Hypercall, and thus cannot switch to Hypervisor to acquire a higher operation permission.

### SUMMARY

Embodiments of this specification provide a hypercall method and apparatus for a kernel-mode program of an extended Berkeley packet filter.

According to a first aspect of the embodiments of this specification, there is provided a hypercall method for a kernel-mode program of an extended Berkeley packet filter, which is applied to a virtual machine monitor, the method including:
acquiring, in response to a virtualization page fault triggered by the kernel-mode program, a memory address where the virtualization page fault is triggered;
determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
reading, from the mapping table, a page fault value mapped by the page fault key if the memory address of the virtualization page fault is consistent with the memory address corresponding to the page fault key, wherein the page fault value includes a function type of a hypercall written by the kernel-mode program before the virtualization page fault is triggered; and
executing, based on the function type indicated by the page fault value, the hypercall of the function type.

Optionally, the virtualization page fault triggered by the kernel-mode program includes:
a virtualization page fault triggered in response to the kernel-mode program writing the function type of the hypercall into the page fault value mapped by the page fault key in the mapping table.

Optionally, different page fault keys are used for denoting different numbers of parameters; the method further includes:
sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter.

Executing, based on the function type indicated by the page fault value, the hypercall of the function type includes:
acquiring, based on identity information of a virtual machine where the virtual machine monitor is located, a mapping table maintained by an extended Berkeley packet filter in the virtual machine; and
modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

According to a second aspect of the embodiments of this specification, there is provided a hypercall method for a kernel-mode program of an extended Berkeley packet filter, which is applied to the kernel-mode program, the method including:
reading, in response to a hypercall instruction, a negotiation value mapped by a negotiation key in a mapping table maintained by the extended Berkeley packet filter; wherein the mapping table records a mapping relationship between a key-value pair, and the negotiation value includes a value written in advance by a virtual machine monitor for indicating a page fault key, and the negotiation key and the page fault key are keys in the mapping table determined jointly by the kernel-mode program and the virtual machine monitor;
querying, based on the negotiation value, the page fault key mapped in the mapping table; and
writing a function type of a hypercall specified in the hypercall instruction into a page fault value mapped by the page fault key, thereby triggering a virtualization page fault, to cause the virtual machine monitor to execute, in response to the virtualization page fault, based on the function type indicated by the page fault value, the hypercall of the function type.

Optionally, the method further includes:
sequentially writing, in a case where the hypercall instruction further specifies at least one parameter of the hypercall, the at least one parameter into a parameter value mapped by at least one parameter key starting from a first parameter key in the mapping table, so that one parameter value corresponds to one parameter.

According to a third aspect of the embodiments of this specification, there is provided a hypercall apparatus for a kernel-mode program of an extended Berkeley packet filter, which is applied to a virtual machine monitor, the apparatus including:
a responding unit, used for acquiring, in response to a virtualization page fault triggered by the kernel-mode program, a memory address where the virtualization page fault is triggered;
a determining unit, used for determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
a reading unit, used for reading, from the mapping table, a page fault value mapped by the page fault key if the memory address of the virtualization page fault is consistent with the memory address corresponding to the page fault key, wherein the page fault value comprises a function type of a hypercall written by the kernel-mode program before the virtualization page fault is triggered; and
a calling unit, used for executing, based on the function type indicated by the page fault value, the hypercall of the function type.

Optionally, the responding unit is further used for triggering a virtualization page fault in response to the kernel-mode program writing the function type of the hypercall into the page fault value mapped by the page fault key in the mapping table.

Optionally, different page fault keys are used for denoting different numbers of parameters.

The reading unit is further used for sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter.

The calling unit is further used for executing, based on the parameter indicated by the parameter value and the function type indicated by the page fault value, the hypercall of the function type.

Optionally, the apparatus further includes:
a writing unit, used for acquiring, based on identity information of a virtual machine where the virtual machine monitor is located, a mapping table maintained by an extended Berkeley packet filter in the virtual machine; and modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

According to a fourth aspect of the embodiments of this specification, there is provided a hypercall apparatus for a kernel-mode program of an extended Berkeley packet filter, which is applied to the kernel-mode program, the apparatus including:
a responding unit, used for reading, in response to a hypercall instruction, a negotiation value mapped by a negotiation key in a mapping table maintained by the extended Berkeley packet filter; wherein the mapping table records a mapping relationship between a key-value pair, and the negotiation value comprises a value written in advance by a virtual machine monitor for indicating a page fault key, and the negotiation key and the page fault key are keys in the mapping table determined jointly by the kernel-mode program and the virtual machine monitor;
a querying unit, used for querying, based on the negotiation value, a page fault key mapped in the mapping table; and
a calling unit, used for writing a function type of a hypercall specified in the hypercall instruction into a page fault value mapped by the page fault key, thereby triggering a virtualization page fault, to cause the virtual machine monitor to execute, in response to the virtualization page fault, based on the function type indicated by the page fault value, the hypercall of the function type.

Optionally, the calling unit is further used for sequentially writing, in a case where the hypercall instruction further specifies at least one parameter of the hypercall, the at least one parameter into a parameter value mapped by at least one parameter key starting from a first parameter key in the mapping table, so that one parameter value corresponds to one parameter.

According to a fifth aspect of the embodiments of this specification, there is provided an electronic device, including:
a processor; and
a memory for storing processor-executable instructions,
wherein the processor is configured to execute any of the above hypercall methods for the kernel-mode program of the extended Berkeley packet filter.

According to a sixth aspect of the embodiments of this specification, there is provided a computer-readable storage medium, wherein in a case where instructions in the computer-readable storage medium are executed by a processor of an electronic device, the electronic device is enabled to execute any of the above hypercall methods for the kernel-mode program of the extended Berkeley packet filter.

The embodiments of this specification provide a hypercall solution for a kernel-mode program of an extended Berkeley packet filter, which provides, based on virtualization page fault technology, a hypercall function for the kernel-mode program of the extended Berkeley packet filter; and implements an indirect hypercall by calling the provided hypercall function without modifying kernel source codes.

### BRIEF DESCRIPTION OF THE DRAWINGS

FIG. 1 is a flow chart of a hypercall method for a kernel-mode program of an extended Berkeley packet filter provided in an embodiment of this specification;

FIG. 2 is a schematic diagram of a Map provided in an embodiment of this specification;

FIG. 3 is a schematic diagram of a method embodiment provided in an embodiment of this specification with a virtual machine monitor as an execution subject;

FIG. 4 is a schematic diagram of a method embodiment provided in an embodiment of this specification with a kernel-mode program as an execution subject;

FIG. 5 is a hardware structural diagram of a hypercall apparatus for a kernel-mode program of an extended Berkeley packet filter provided in an embodiment of this specification;

FIG. 6 illustrates modules of a hypercall apparatus for a kernel-mode program of an extended Berkeley packet filter provided in an embodiment of this specification; and

FIG. 7 illustrates modules of a hypercall apparatus for a kernel-mode program of an extended Berkeley packet filter provided in an embodiment of this specification.

### DETAILED DESCRIPTION

Exemplary embodiments will now be explained in detail, examples of which are illustrated in the drawings. In a case where the following description refers to the drawings, the same numerals in different drawings denote the same or similar elements, unless otherwise denoted. The implementations described in the following exemplary embodiments do not represent all implementations consistent with this specification. Instead, they are merely instances of apparatuses and methods consistent with some aspects of this specification as detailed in the appended claims.

The terms used in the embodiments of this specification are only for the purpose of describing particular embodiments, and are not intended to limit the embodiments of this specification. Singular forms of “a/an”, “the” and “this” used in this specification and the appended claims are also intended to include the plural forms, unless otherwise clearly indicated in the context. It should also be understood that the term “and/or” used herein refers to and contains any or all possible combinations of one or more associated listed items.

It should be understood that although various information may be described employing terms such as first, second, and third in this specification, such information should not be limited to these terms. These terms are only used to distinguish information of the same type from each other. For example, without departing from the scope of this specification, a first information may also be referred to as a second information, and similarly, the second information may also be referred to as the first information. Depending on the context, the word “if” as used here may be interpreted as “as” or “when” or “determining . . . in response to . . . ”.

As mentioned above, a kernel-mode program of an extended Berkeley packet filter (hereinafter referred to as eBPF) cannot directly call a hyper call (hereinafter referred to as a Hypercall), and thus it is impossible to switch from the kernel-mode program to a virtual machine monitor (hereinafter referred to as Hypervisor) to acquire a higher operation permission.

In related technologies, Hypercall of a kernel-mode program of an eBPF may be implemented by modifying kernel source codes. Specifically, an existing kernel is defined with a series of Helper auxiliary functions, but no Helper auxiliary function is provided therein for implementing a Hypercall function. To this end, an implementation of calling the Hypercall through the Helper auxiliary function is achieved by modifying the kernel source codes. However, this way needs to modify the kernel source codes, and its applicability is poor, which cannot achieve massive popularization.

This specification provides a hypercall solution for a kernel-mode program of an extended Berkeley packet filter, which can implement a Hypercall function of the kernel-mode program of eBPF without modifying kernel source codes.

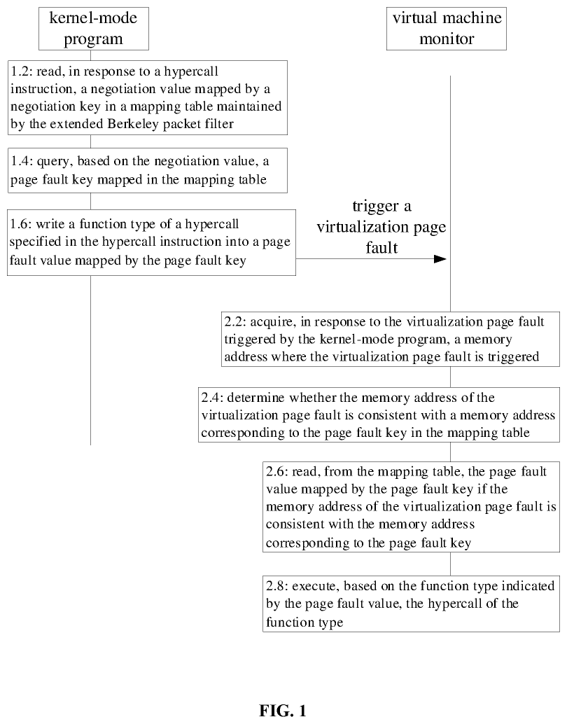

With reference to FIG. 1, an introduction will be made below to a flowchart of an embodiment of a hypercall method for a kernel-mode program of an extended Berkeley packet filter provided in this specification, the method including:
at step 1.2, reading, by the kernel-mode program, in response to a hypercall instruction, a negotiation value mapped by a negotiation key in a mapping table maintained by the extended Berkeley packet filter; wherein the mapping table records a mapping relationship between a key-value pair, and the negotiation value comprises a value written in advance by a virtual machine monitor for indicating a page fault key, and the negotiation key and the page fault key are keys in the mapping table determined jointly by the kernel-mode program and the virtual machine monitor.
at step 1.4, querying, by the kernel-mode program, based on the negotiation value, a page fault key mapped in the mapping table.
at step 1.6, writing, by the kernel-mode program, a function type of a hypercall specified in the hypercall instruction into a page fault value mapped by the page fault key, thereby triggering a virtualization page fault.
at step 2.2: acquiring, by the virtual machine monitor, in response to the virtualization page fault triggered by the kernel-mode program, a memory address where the virtualization page fault is triggered.
at step 2.4, determining, by the virtual machine monitor, whether the memory address of the virtualization page fault is consistent with a memory address corresponding to the page fault key in the mapping table, wherein each key in the mapping table uniquely corresponds to one memory address.
at step 2.6, reading, by the virtual machine monitor, from the mapping table, the page fault value mapped by the page fault key if the memory address of the virtualization page fault is consistent with the memory address corresponding to the page fault key.
at step 2.8, executing, by the virtual machine monitor, based on the function type indicated by the page fault value, the hypercall of this function type.

In this specification, at least one virtual machine may be generated in a kernel through virtualization technology, and an eBPF (extended Berkeley packet filter) may be run in each virtual machine, and in the eBPF, one or more mapping tables will be maintained. In this way, the virtual machine then may include a kernel-mode program of the eBPF, a mapping table, and a Hypervisor (a virtual machine monitor) of the virtual machine itself.

The above mapping table may be understood as a data structure for recording a mapping relationship between a key-value pair (i.e., key-value), such as a Map. The Map is a general-purpose key-value storage structure that may be used to store any type of data. Each key in the mapping table corresponds to one memory address.

In the eBPF, a mapping table is generally used to provide bidirectional communication between a user-mode program and a kernel-mode program, to implement data interaction between the user-mode program and the kernel-mode program.

In this specification, the configuration or improvement of the above mapping table may also be used to provide bidirectional communication between the eBPF and the Hypervisor, to implement data interaction between a kernel-mode program of the eBPF and the Hypervisor. Specifically, the configuration or improvement of the above mapping table will be explained in subsequent embodiments.

Taking such mapping tables as the Map as an instance, the Map also derives different types of Map to meet demands from different scenarios, such as Array Map, Hash Map, and the like. Different Map types have different characteristics and functions.

Taking the Array Map as an instance, since the Array Map has the characteristics of high query efficiency and low memory occupation, the read-write efficiency of the Map can be improved in a case where the Array Map is used as an eBPF Map. For the embodiments in this specification, improving the read-write efficiency of the Map means improving the response efficiency during a hypercall for the kernel-mode program.

The following further introduces that the mapping table is configured or improved to implement data interaction between the kernel-mode program of the eBPF and the Hypervisor.

In this specification, it is necessary to register one or more negotiation keys in the mapping table. A negotiation value corresponding to each negotiation key may be a page fault key written in advance by the Hypervisor, that is, the negotiation value may be used to indicate the page fault key. The negotiation key and the page fault key may be keys determined in advance in the mapping table jointly by the kernel-mode program and the Hypervisor.

It should be explained that one page fault key may only exist in one negotiation value at the same moment, thereby avoiding the occurrence of abnormal conflicts caused by different negotiation values simultaneously pointing to one page fault key.

In an exemplary embodiment, before the Hypervisor writes a negotiation value, a mapping table needs to be acquired first, and this acquisition way may include:

The Hypervisor may acquire, based on identity information of a virtual machine where the virtual machine monitor is located, a mapping table maintained by an extended Berkeley packet filter in the virtual machine; and further modify a negotiation value mapped by a negotiation key in the mapping table to be a page fault key, so that the negotiation value mapped by the negotiation key maintained by the mapping table indicates the page fault key.

During implementation, the Hypervisor may use a kernel analysis tool (e.g., Crash Utility) to acquire the above mapping table. Generally, the kernel analysis tool may perform location based on the identity information of the virtual machine as the unique identifier, and acquire the mapping table from the located virtual machine. The identity information may include, but is not limited to, a kernel version (e.g., a Linux Kernel version) of the virtual machine, a symbol table, a key data structure and other information.

It should be explained that, in some embodiments, the Hypervisor may also acquire the mapping table directly based on the identity information of the virtual machine with no aid of the kernel analysis tool.

After the Hypervisor writes a page fault key in a negotiation value, this negotiation value may point to the page fault key in the mapping table. It should be explained that a page fault value of the page fault key may be null initially, and subsequently a value of this page fault value needs to be written by the kernel-mode program (this process will be explained in a following embodiment).

In the following, with reference to a schematic diagram of a Map shown in FIG. 2, assuming that a first key is a negotiation key and a corresponding negotiation value is X, then a page fault key corresponding to this negotiation value in the Map is key=X at GPA0.

After the Hypervisor writes a negotiation value, the Hypervisor also needs to build a virtualization page fault for a page fault key, such that in a case where an eBPF kernel-mode program subsequently writes any data in a page fault value corresponding to the page fault key, the virtualization page fault may be triggered.

A way to build the virtualization page fault for the page fault key above may be to remove a virtual address of the page fault key from a page table. The page table is a table for managing a mapping relationship between virtual addresses and physical addresses. In addition, after removing the virtual address of the page fault key from the page table, the Hypervisor needs to intercept addition of mapping of the virtual address for the page fault key in order to retain the virtualization page fault.

After the Hypervisor writes the negotiation value, the kernel-mode program of the eBPF then may use a Hypercall function to indirectly implement calling of a Hypercall.

During implementation, the kernel-mode program of the eBPF may receive, for example, an instruction initiated from a user-mode program. If this instruction needs to be executed by the Hypervisor, the kernel-mode program needs to use a Hypercall. An instruction that needs to use the Hypercall is hereinafter referred to as a Hypercall instruction.

In response to a Hypercall instruction, the kernel-mode program first needs to read a negotiation value corresponding to a negotiation key in the mapping table.

Then, using the negotiation value as an index, a page fault key pointed to by the negotiation value in the mapping table is queried.

Finally, a function type of the Hypercall specified in the Hypercall instruction is written as a value in a page fault value corresponding to the page fault key, thereby triggering a virtualization page fault.

Correspondingly, the Hypervisor may acquire, in response to the virtualization page fault triggered by the kernel-mode program, a memory address where the virtualization page fault is triggered, and determining whether the memory address of the virtualization page fault is consistent with a memory address corresponding to the page fault key.

If the memory address of the virtualization page fault is consistent with the memory address corresponding to the page fault key, the Hypervisor may determine that the eBPF kernel-mode program does initiate a Hypercall call, and may, in turn, use the negotiation value as an index to query a page fault key pointed to by the negotiation value in the mapping table.

Since, at this time, the value denoting the function type of the Hypercall has been written in the page fault value corresponding to the page fault key by the kernel-mode program, it may be therefore determined, by reading the page fault value corresponding to the page fault key, which Hypercall function type of the Hypercall needs to be executed currently, and execution of the Hypercall may, in turn, be completed

In applying the above embodiments, the kernel-mode program of the eBPF does not directly call the Hypercall, but establishes, by setting the negotiation key and the page fault key in the mapping table, a corresponding relationship between the negotiation value corresponding to the negotiation key and the page fault key. The virtualization page fault technology, in turn, is utilized to make the page fault value mapped by the page fault key serve as a data transfer carrier of the Hypercall function type, to implement information interaction between the kernel-mode program and the Hypervisor. The Hypervisor is ultimately caused to execute the Hypercall of the transferred Hypercall function type; this is actually a way to indirectly implement the Hypercall.

On the one hand, the page fault value may be written in with any Hypercall function type, which can provide a Hypercall of a full-function type for the kernel-mode program of the eBPF.

On the other hand, since the above way to indirectly implement the Hypercall does not need to modify a kernel source code of the virtual machine, it can be widely used as a hypercall solution for a kernel-mode program of a general-purpose eBPF.

In practical applications, some services may be executed properly only by transmitting particular parameters, and there is also a demand for transmission of parameters at the time of calling a Hypercall. However, since the page fault value in the mapping table has been used to be written in with the function type of the Hypercall, which can no longer be used to transfer parameters of the Hypercall, the above embodiment may therefore only provide a Hypercall without parameters, and cannot provide a Hypercall with parameters.

In order to solve this problem, this specification further provides the following embodiments to implement a Hypercall with parameters for a kernel-mode program in an extended Berkeley packet filter, and such Hypercall can support transfer of any number of parameters.

Specifically, a plurality of page fault keys may be set in a mapping table, and different page fault keys may be used to denote different numbers of parameters; correspondingly, different page fault keys also need to be written into negotiation values corresponding to different negotiation keys; and parameter keys are set for writing in different parameters. Similar to the negotiation keys and the page fault keys, the parameter keys may also be determined by the kernel-mode program and the Hypervisor after negotiation.

At the above step 1.6, it may further include:
sequentially writing, by the kernel-mode program, in a case where the hypercall instruction further specifies at least one parameter of the hypercall, the at least one parameter into a parameter value mapped by at least one parameter key starting from a first parameter key in the mapping table, so that one parameter value corresponds to one parameter.

In this example, for the kernel-mode program, the corresponding negotiation value needs to be read according to the number of parameters in the Hypercall instruction. In addition, the kernel-mode program not only needs to write a function type of a to-be-executed Hypercall specified in the Hypercall instruction as a value into the page fault value mapped by the page fault key pointed to by the negotiation value, but also needs to sequentially write the at least one parameter as a value into the parameter value mapped by the at least one parameter key starting from the first parameter key, so that one parameter value corresponds to one parameter.

Correspondingly, at the above step 2.6, it may further include:
sequentially reading, by the virtual machine monitor, based on the number of parameters denoted by the page fault key, parameter keys of the number of parameters starting from a first parameter key in the mapping table, to acquire a parameter value mapped by each parameter key.

In this example, for the Hypervisor, it may be determined, according to the memory address of the virtualization page fault, how many parameters the Hypercall carries. Then, the parameter keys of the number of parameters may be sequentially read from the first parameter key in the mapping table, to acquire the parameter value mapped by each parameter key. Finally, the Hypercall of the function type is executed based on the parameter indicated by the parameter value and the function type indicated by the page fault value.

Explanation is made still with reference to the schematic diagram of the Map shown in FIG. 2. Assume that a memory address GPA0 corresponding to a page fault key=X denotes no parameter, a memory address GPA1 corresponding to a page fault key=X+1 denotes that there is one parameter, and a memory address GPA2 corresponding to a page fault key=X+2 denotes that there are two parameters.

As such, if the Hypercall instruction is a Hypercall_type1 function type without parameters, the eBPF kernel-mode program may read a value=X corresponding to a negotiation key=0 without parameters, thereby writing a Hypercal_type1 into a page fault value corresponding to a page fault key=X, to trigger a virtualization page fault. The memory address GPA0 of the virtualization page fault acquired by the Hypervisor indicates a Hypercall without parameters, and it is therefore unnecessary to read parameters, and it only needs to execute the Hypercall without parameters based on the Hypercall_type1 function type indicated by this negotiation value.

For another example, if the Hypercall instruction is a Hypercall_type2 function type with one parameter, the eBPF kernel-mode program may read a value=X+1 of a negotiation key=1 corresponding to the one parameter, thereby writing a Hypercal_type2 into a page fault value corresponding to a page fault key=X+1, and writing a parameter 1 into a parameter value corresponding to a first parameter key=Y, to trigger a virtualization page fault. The memory address GPA1 of the virtualization page fault acquired by the Hypervisor indicates a Hypercall with one parameter, and it is therefore necessary to read the parameter 1 from the parameter value corresponding to parameter key=Y, and read the Hypercall_type2 function type from the page fault value corresponding to the page fault key=X+1. Finally, the Hypercall is executed based on the parameter 1 and the Hypercall_type2 function type.

For another example, if the Hypercall instruction is a Hypercall_type3 function type with two parameters, the eBPF kernel-mode program may read a value=X+2 of a negotiation key=2 corresponding to the two parameters, thereby writing a Hypercal_type3 into a page fault value corresponding to a page fault key=X+2, and writing a parameter 1 into a parameter value corresponding to a first parameter key=Y, and writing a parameter 2 into a parameter value corresponding to a second parameter key=Y+1, to trigger a virtualization page fault. The memory address GPA2 of the virtualization page fault acquired by the Hypervisor indicates a Hypercall with two parameters, and it is therefore necessary to read the parameter 1 and the parameter 2 from the parameter values corresponding to the parameter key=Y and the parameter key=Y+1 respectively, and read the Hypercall_type3 function type from the page fault value corresponding to the page fault key=X+2. Finally, the Hypercall is executed based on the parameter 1, the parameter 2 and the Hypercall_type3 function type.

Likewise, similar processing is performed for three parameters, four parameters . . . in the Hypercall instruction, which will be not repeated here.

In applying the above examples, by setting the parameter key in the mapping table and using the parameter value mapped by the parameter key as a data transfer carrier of the Hypercall parameter, in cooperation with the page fault value, not only can a full-function Hypercall be implemented, but also Hypercalls with different numbers of parameters can be supported.

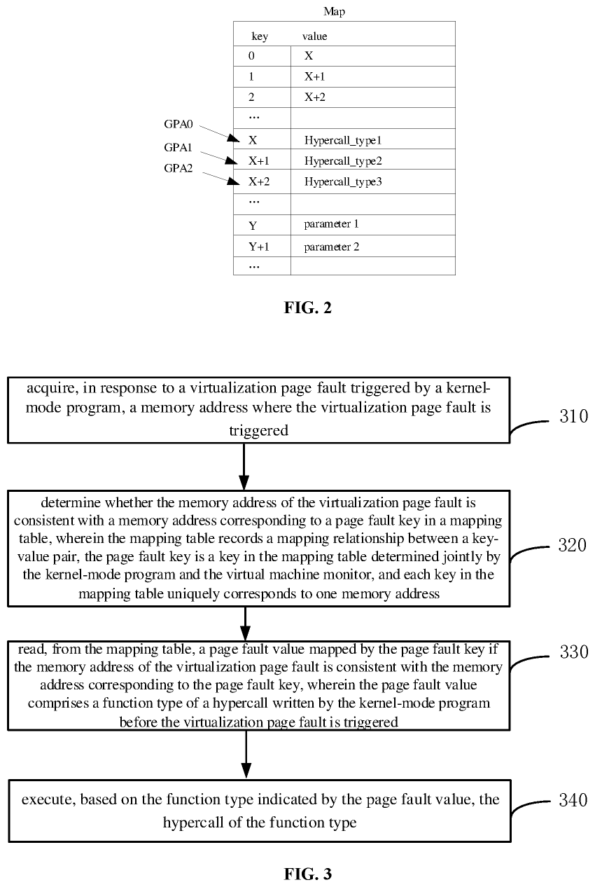

The following refers to a schematic diagram of a method embodiment shown in FIG. 3 with a Hypervisor as an execution subject, the method including:
at step 310, acquiring, in response to a virtualization page fault triggered by a kernel-mode program, a memory address where the virtualization page fault is triggered;
at step 320, determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
at step 330, reading, from the mapping table, a page fault value mapped by the page fault key if the memory address of the virtualization page fault is consistent with the memory address corresponding to the page fault key, wherein the page fault value includes a function type of a hypercall written by the kernel-mode program before the virtualization page fault is triggered; and
at step 340, executing, based on the function type indicated by the page fault value, the hypercall of the function type.

The embodiment shown above in FIG. 3 and subsequent optional embodiments all may correspond to the foregoing embodiment shown in FIG. 1, and details of specific steps may refer to the embodiments related to FIG. 1, which will not be repeated here.

In applying the above embodiments, by setting negotiation keys and page fault keys in the mapping table and establishing a corresponding relationship between negotiation values corresponding to the negotiation keys and the page fault keys, the virtualization page fault technology, in turn, is utilized to make the page fault values mapped by the page fault keys serve as data transfer carriers of the Hypercall function types, to implement information interaction between the kernel-mode program and the Hypervisor.

Specifically, after the kernel-mode program writes the Hypercall function type into the page fault value mapped by the page fault key, the virtualization page fault is triggered. In response to the virtualization page fault, the Hypervisor reads the Hypercall function type written by the kernel-mode program into the page fault value mapped by the page fault key, thereby executing the Hypercall of this Hypercall function type. As such, indirect calling of the Hypercall by the kernel-mode program of the eBPF is implemented.

On the one hand, any Hypercall function type may be written into the page fault value, which can provide a Hypercall of a full-function type for the kernel-mode program of the eBPF.

On the other hand, since the above way to indirectly implement the Hypercall does not need to modify a kernel source code of the virtual machine, it can be used as a hypercall solution for a kernel-mode program of a general-purpose extended Berkeley packet filter.

In an exemplary optional embodiment, at the step 310, the virtualization page fault triggered by the kernel-mode program may include:
a virtualization page fault triggered in response to the kernel-mode program writing the function type of the hypercall into the page fault value mapped by the page fault key in the mapping table.

In applying the above example, by setting the page fault key, in a case where the kernel-mode program of the eBPF writes any data in the page fault value mapped by the page fault key, the virtualization page fault may be triggered, thereby utilizing the page fault value as a data transfer carrier of the Hypercall function type, to implement information interaction between the kernel-mode program of the eBPF and the Hypervisor of the virtual machine.

In an exemplary optional embodiment, different page fault keys are used for denoting different numbers of parameters; and on the basis of the embodiment shown in FIG. 3, the method may further include:
sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter.

The step 340 of executing, based on the function type indicated by the page fault value, the hypercall of the function type may include:
executing, based on the parameter indicated by the parameter value and the function type indicated by the page fault value, the hypercall of the function type.

In applying the above example, by setting the parameter key in the mapping table and using the parameter value mapped by the parameter key as a data transfer carrier of the Hypercall parameter, in cooperation with the page fault value, the Hypercall with parameters can be implemented, and transfer of any number of parameters can be supported.

In an exemplary optional embodiment, before the above step 310, the method may further include:
acquiring, based on identity information of a virtual machine where the virtual machine monitor is located, a mapping table maintained by an extended Berkeley packet filter in the virtual machine; and
modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

In applying the above example, Hypervisor acquires the mapping table of the eBPF through the identity information of the virtual machine, and, in turn, writes the negotiation value used to point to the page fault key. Furthermore, after the negotiation value is written, the kernel-mode program then may have the Hypercall function, and, in turn, implement the Hypercall of the kernel-mode program.

The following refers to a schematic diagram of a method embodiment shown in FIG. 4 with a kernel-mode program as an execution subject, and the method includes:
at step 410, reading, in response to a hypercall instruction, a negotiation value mapped by a negotiation key in a mapping table maintained by the extended Berkeley packet filter; wherein the mapping table records a mapping relationship between a key-value pair, and the negotiation value comprises a value written in advance by a virtual machine monitor for indicating a page fault key, and the negotiation key and the page fault key are keys in the mapping table determined jointly by the kernel-mode program and the virtual machine monitor;
at step 420, querying, based on the negotiation value, a page fault key mapped in the mapping table; and
at step 430, writing a function type of a hypercall specified in the hypercall instruction into a page fault value mapped by the page fault key, thereby triggering a virtualization page fault, to cause the virtual machine monitor to execute, in response to the virtualization page fault, based on the function type indicated by the page fault value, the hypercall of the function type.

The embodiment shown above in FIG. 4 and subsequent optional embodiments all may correspond to the foregoing embodiment shown in FIG. 1, and details of specific steps may refer to the embodiments related to FIG. 1, which will not be repeated here.

In applying the above embodiments, by setting negotiation keys and page fault keys in the mapping table and establishing a corresponding relationship between negotiation values corresponding to the negotiation keys and the page fault keys, the virtualization page fault technology, in turn, is utilized to make the page fault values mapped by the page fault keys serve as data transfer carriers of the Hypercall function types, to implement information interaction between the kernel-mode program and the Hypervisor.

Specifically, after the kernel-mode program writes the Hypercall function type into the page fault value mapped by the page fault key, the virtualization page fault is triggered. In response to the virtualization page fault, the Hypervisor reads the Hypercall function type written by the kernel-mode program into the page fault value mapped by the page fault key, thereby executing the Hypercall of this Hypercall function type. As such, indirect calling of the Hypercall by the kernel-mode program of the eBPF is implemented.

On the one hand, any Hypercall function type may be written into the page fault value, which can provide a Hypercall of a full-function type for the kernel-mode program of the eBPF.

On the other hand, since the above way to indirectly implement the Hypercall does not need to modify a kernel source code of the virtual machine, it can be used as a hypercall solution for a kernel-mode program of a general-purpose extended Berkeley packet filter.

In an exemplary optional embodiment, the method further includes:
sequentially writing, in a case where the hypercall instruction further specifies at least one parameter of the hypercall, the at least one parameter as a value into a parameter value mapped by at least one parameter key starting from a first parameter key in the Map, so that one parameter value corresponds to one parameter.

Causing the virtual machine monitor to execute, based on the function type indicated by the page fault value, the hypercall of the function type includes:
causing the virtual machine monitor to execute, based on the parameter indicated by the parameter value and the function type indicated by the page fault value, the hypercall of the function type.

In applying the above example, by setting the parameter key in the Map and using the parameter value corresponding to the parameter key as a data transfer carrier of the Hypercall parameter, in cooperation with the page fault value, a Hypercall with parameters can be implemented, and transfer of any number of parameters can be supported.

This embodiment corresponds to the foregoing embodiment shown in FIG. 1, and details of specific steps may refer to the embodiment of FIG. 1, which will not be repeated here.

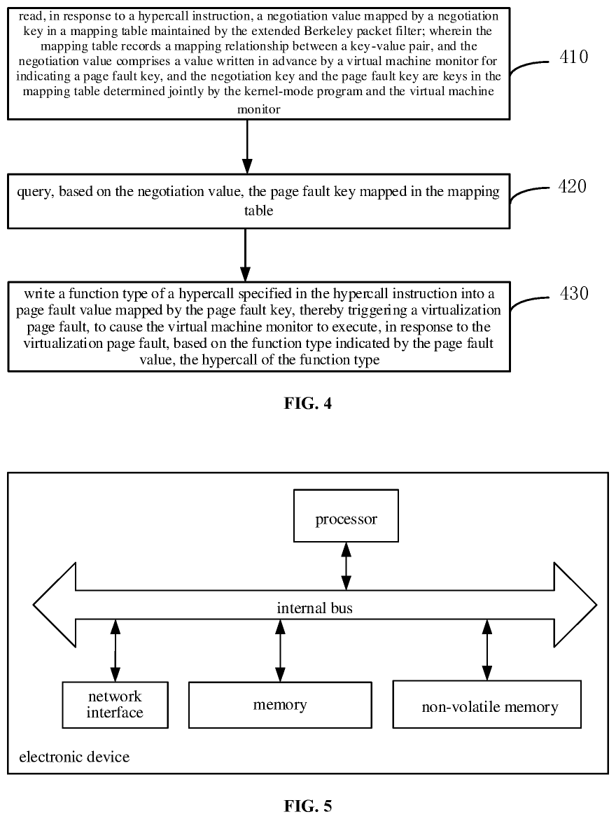

Corresponding to the foregoing embodiments of the hypercall methods for the kernel-mode program of the extended Berkeley packet filter, this specification further provides embodiments of hypercall apparatuses for the kernel-mode program of the extended Berkeley packet filter. The apparatus embodiments may be implemented by software, or may also be implemented by means of hardware, or a combination of software and hardware. Taking a software implementation as an example, as one apparatus logically, it is formed by reading corresponding computer service program instructions in a non-volatile memory into a memory for running by a processor of a device where it is located. From a hardware level, FIG. 5 is shown as a hardware structural diagram of a device where a hypercall apparatus for a kernel-mode program of an extended Berkeley packet filter is located. In addition to the processor, network interface, memory, and non-volatile memory shown in FIG. 5, in the embodiment, the device where the apparatus is located usually may further include other hardware according to hypercall actual functions of the kernel-mode program of the enhanced Berkeley packet filter, which will not be repeated here.

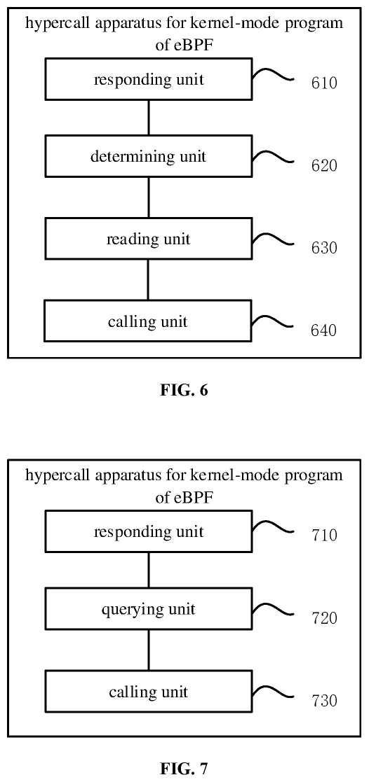

Please refer to FIG. 6, which is a module diagram of a hypercall apparatus for a kernel-mode program of an extended Berkeley packet filter provided in an embodiment of this specification. The apparatus corresponds to the embodiment shown in FIG. 3, which is applied to a virtual machine monitor, the apparatus including:
a responding unit 610, used for acquiring, in response to a virtualization page fault triggered by the kernel-mode program, a memory address where the virtualization page fault is triggered;
a determining unit 620, used for determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
a reading unit 630, used for reading, from the mapping table, a page fault value mapped by the page fault key if the memory address of the virtualization page fault is consistent with the memory address corresponding to the page fault key, wherein the page fault value comprises a function type of a hypercall written by the kernel-mode program before the virtualization page fault is triggered; and
a calling unit 640, used for executing, based on the function type indicated by the page fault value, the hypercall of the function type

Optionally, the responding unit 610 is further used for triggering the virtualization page fault in response to the kernel-mode program writing the function type of the hypercall into the page fault value mapped by the page fault key in the mapping table.

Optionally, different page fault keys are used for denoting different numbers of parameters.

The reading unit 630 is further used for sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter.

The calling unit 640 is further used for executing, based on the parameter indicated by the parameter value and the function type indicated by the page fault value, the hypercall of the function type.

Optionally, the apparatus further includes:
a writing unit, used for acquiring, based on identity information of a virtual machine where the virtual machine monitor is located, a mapping table maintained by an extended Berkeley packet filter in the virtual machine; and modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

Please refer to FIG. 7, which is a module diagram of a hypercall apparatus for a kernel-mode program of an extended Berkeley packet filter provided in an embodiment of this specification. The apparatus corresponds to the embodiment shown in FIG. 4, which is applied to a kernel-mode program, the apparatus including:
a responding unit 710, used for reading, in response to a hypercall instruction, a negotiation value mapped by a negotiation key in a mapping table maintained by the extended Berkeley packet filter; wherein the mapping table records a mapping relationship between a key-value pair, and the negotiation value comprises a value written in advance by a virtual machine monitor for indicating a page fault key, and the negotiation key and the page fault key are keys in the mapping table determined jointly by the kernel-mode program and the virtual machine monitor;
a querying unit 720, used for querying, based on the negotiation value, the page fault key mapped in the mapping table; and
a calling unit 730, used for writing a function type of a hypercall specified in the hypercall instruction into a page fault value mapped by the page fault key, thereby triggering a virtualization page fault, to cause the virtual machine monitor to execute, in response to the virtualization page fault, based on the function type indicated by the page fault value, the hypercall of the function type.

Optionally, the calling unit 730 is further used for sequentially writing, in a case where the hypercall instruction further specifies at least one parameter of the hypercall, the at least one parameter into a parameter value mapped by at least one parameter key starting from a first parameter key in the mapping table, so that one parameter value corresponds to one parameter.

The systems, apparatuses, modules, or units set forth in the above embodiments may be specifically implemented by a computer chip or entity, or implemented by a product having a certain function. A typical implementation device is a computer, a specific form of which may be a personal computer, a laptop computer, a cellular phone, a camera phone, a smart phone, a personal digital assistant, a media player, a navigation device, an email transceiver device, a game console, a tablet computer, a wearable device, or a combination of any of these devices.

Details of implementation processes of functions and effects of each unit in the above apparatuses may specifically refer to implementation processes of corresponding steps in the above methods, which will not be repeated here.

For the apparatus embodiments, since they basically correspond to the method embodiments, the relevant parts may refer to some of the explanations of the method embodiments. The apparatus embodiments described above are merely exemplary, in which units explained as discrete components may or may not be physically separated, and components shown as units may or may not be physical units, that is, may be located in one place, or may also be distributed over a plurality of network units. Some or all of the modules may be selected according to actual needs to achieve the objectives of the solutions of this specification. Those of ordinary skill in the art can understand and implement without creative labor.

Internal functional modules and structures of execution apparatuses of a smart contract in a blockchain described above in FIGS. 6 and 7 are schematic, and an execution entity of which essentially may be an electronic device, including:
a processor; and
a memory for storing processor-executable instructions;
wherein the processor is configured to execute any one of the hypercall embodiments for the kernel-mode program of the extended Berkeley packet filter.

In the embodiment of the above electronic device, it should be understood that this processor may be a central processing unit (CPU), or may also be other general-purpose processors, a digital signal processor (DSP), an application specific integrated circuit (ASIC), or the like. A general-purpose processor may be a microprocessor, or this processor may also be any regular processor, or the like. The above memory may be a read-only memory (ROM), a random access memory (RAM), a flash memory, a hard disk, or a solid state disk. With reference to the steps of the methods disclosed in the embodiments of the present invention, they may be directly embodied as being executed by a hardware processor, or being executed by a combination of hardware and software modules in a processor.

The embodiments in this specification are described in a progressive manner, the same and similar parts between the embodiments may refer to each other, and each embodiment focuses on a difference from other embodiments. Especially, for the embodiment of the electronic device, since it is basically similar to the method embodiments, it is described in a relatively simple manner, and the relevant parts may refer to some of the explanations of the method embodiments.

Upon consideration of the specification and practice of the invention disclosed here, those skilled in the art will readily envisage other implementations of this specification. This specification is intended to cover any variants, uses or adaptative changes of this specification, and these variants, uses or adaptive changes follow the general principles of this specification and include the common general knowledge or customary technical means in this technical field not disclosed in this specification. The specification and embodiments are considered as exemplary only, and the true scope and spirit of this specification are pointed out in the following claims.

It should be understood that this specification is not limited to the precise structures that have been described above and shown in the drawings, and various modifications and changes may be made without departing from the scope thereof. The scope of this specification is limited only by the appended claims.

1. A hypercall method for a kernel-mode program of an extended Berkeley packet filter, which is applied to a virtual machine monitor, the method comprising:
acquiring, in response to a virtualization page fault triggered by the kernel-mode program, a memory address where the virtualization page fault is triggered;
determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
reading, from the mapping table, a page fault value mapped by the page fault key if the memory address of the virtualization page fault is consistent with the memory address corresponding to the page fault key, wherein the page fault value comprises a function type of a hypercall written by the kernel-mode program before the virtualization page fault is triggered; and
executing, based on the function type indicated by the page fault value, the hypercall of the function type.

2. The method according to claim 1, wherein the virtualization page fault triggered by the kernel-mode program comprises:
a virtualization page fault triggered in response to the kernel-mode program writing the function type of the hypercall into the page fault value mapped by the page fault key in the mapping table.

3. The method according to claim 1, wherein different page fault keys are used for denoting different numbers of parameters; the method further comprises:
sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter; and
executing, based on the function type indicated by the page fault value [key], the hypercall of the function type comprises:
executing, based on the parameter indicated by the parameter value and the function type indicated by the page fault value, the hypercall of the function type.

4. The method according to claim 1, further comprising:
acquiring, based on identity information of a virtual machine where the virtual machine monitor is located, a mapping table maintained by an extended Berkeley packet filter in the virtual machine; and
modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

5. A hypercall method for a kernel-mode program of an extended Berkeley packet filter, which is applied to the kernel-mode program, the method comprising:
reading, in response to a hypercall instruction, a negotiation value mapped by a negotiation key in a mapping table maintained by the extended Berkeley packet filter; wherein the mapping table records a mapping relationship between a key-value pair, and the negotiation value comprises a value written in advance by a virtual machine monitor for indicating a page fault key, and the negotiation key and the page fault key are keys in the mapping table determined jointly by the kernel-mode program and the virtual machine monitor;
querying, based on the negotiation value, the page fault key mapped in the mapping table; and
writing a function type of a hypercall specified in the hypercall instruction into a page fault value mapped by the page fault key, thereby triggering a virtualization page fault, to cause the virtual machine monitor to execute, in response to the virtualization page fault, based on the function type indicated by the page fault value, the hypercall of the function type.

6. The method according to claim 5, further comprising:
sequentially writing, in a case where the hypercall instruction further specifies at least one parameter of the hypercall, the at least one parameter into a parameter value mapped by at least one parameter key starting from a first parameter key in the mapping table, so that one parameter value corresponds to one parameter.

7. (canceled)

8. (canceled)

9. An electronic device, comprising:
a processor; and
a memory for storing processor-executable instructions, wherein the processor is configured to execute the processor-executable instructions to perform operations of:
acquiring, in response to a virtualization page fault triggered by the kernel-mode program, a memory address where the virtualization page fault is triggered;
determining whether the memory address of the virtualization page fault is consistent with a memory address corresponding to a page fault key in a mapping table, wherein the mapping table records a mapping relationship between a key-value pair, the page fault key is a key in the mapping table determined jointly by the kernel-mode program and the virtual machine monitor, and each key in the mapping table uniquely corresponds to one memory address;
reading, from the mapping table, a page fault value mapped by the page fault key if the memory address of the virtualization page fault is consistent with the memory address corresponding to the page fault key, wherein the page fault value comprises a function type of a hypercall written by the kernel-mode program before the virtualization page fault is triggered; and
executing, based on the function type indicated by the page fault value, the hypercall of the function type.

10. A non-transitory computer-readable storage medium, wherein in a case where instructions in the computer-readable storage medium are executed by a processor of an electronic device, the electronic device is enabled to execute the method according to claim 1.

11. The electronic device according to claim 9, wherein the virtualization page fault triggered by the kernel-mode program comprises:
a virtualization page fault triggered in response to the kernel-mode program writing the function type of the hypercall into the page fault value mapped by the page fault key in the mapping table.

12. The electronic device according to claim 9, wherein different page fault keys are used for denoting different numbers of parameters, and the processor is configured to execute the processor-executable instructions to perform operations of:
sequentially reading, based on the number of parameters denoted by the page fault key, parameter keys of the number of parameters starting from a first parameter key in the mapping table, to acquire a parameter value mapped by each parameter key; wherein the parameter value is a parameter of a hypercall written by the kernel-mode program, and one parameter value corresponds to one parameter; and
executing, based on the function type indicated by the page fault value, the hypercall of the function type comprises:
executing, based on the parameter indicated by the parameter value and the function type indicated by the page fault value, the hypercall of the function type.

13. The electronic device according to claim 9, wherein the processor is configured to execute the processor-executable instructions to perform operations of:
acquiring, based on identity information of a virtual machine where the virtual machine monitor is located, a mapping table maintained by an extended Berkeley packet filter in the virtual machine; and
modifying a negotiation value mapped by a negotiation key in the mapping table to a page fault key, so that the negotiation value mapped by the negotiation key maintained by the mapping table indicates the page fault key; wherein the negotiation key is a key in the mapping table determined jointly by the kernel-mode program and the virtual machine monitor.

14. An electronic device, comprising:
a processor; and
a memory for storing processor-executable instructions,
wherein the processor is configured to execute the processor-executable instructions to perform the method of claim 5.

15. The electronic device according to claim 14, wherein the processor is configured to execute the processor-executable instructions to perform the method of claim 6.

16. The non-transitory computer-readable storage medium according to claim 10, wherein in the case where the instructions in the computer-readable storage medium are executed by the processor of the electronic device, the electronic device is enabled to execute the method according to claim 2.

17. The non-transitory computer-readable storage medium according to claim 10, wherein in the case where the instructions in the computer-readable storage medium are executed by the processor of the electronic device, the electronic device is enabled to execute the method according to claim 3.

18. The non-transitory computer-readable storage medium according to claim 10, wherein in the case where the instructions in the computer-readable storage medium are executed by the processor of the electronic device, the electronic device is enabled to execute the method according to claim 4.

19. A non-transitory computer-readable storage medium, wherein in a case where instructions in the computer-readable storage medium are executed by a processor of an electronic device, the electronic device is enabled to execute the method according to claim 5.

20. The non-transitory computer-readable storage medium according to claim 19, wherein in the case where the instructions in the computer-readable storage medium are executed by the processor of the electronic device, the electronic device is enabled to execute the method according to claim 6.
